(19) United States
(12) Patent Application Publication
(10) Pub. No.: US 2024/0217430 A1
(43) Pub. Date: Jul. 4, 2024

(54) FLIP-UP RACK ILLUMINATION SYSTEM

(71) Applicant: HiViz LED Lighting, Inc., Hendersonville, NC (US)

(72) Inventor: Samuel T. Massa, Hendersonville, NC (US)

(73) Assignee: HiViz LED Lighting, Inc., Hendersonville, NC (US)

(21) Appl. No.: 18/403,315

(22) Filed: Jan. 3, 2024

Related U.S. Application Data
(60) Provisional application No. 63/478,312, filed on Jan. 3, 2023.

(51) Int. Cl. B60Q 1/26; B60Q 1/14; B60Q 1/50

(52) U.S. Cl. CPC B60Q 1/2692; B60Q 1/1423; B60Q 1/2611; B60Q 1/2615; B60Q 1/2696; B60Q 1/525; B60Q 2300/45; B60Q 2800/30

(57) ABSTRACT

A lighting system configured to be coupled to a vehicle, the lighting system including a light source configured to illuminate a target area in front of the vehicle from above, wherein the lighting system is configured to move between a retracted position and an extended position. Further, A method of preventing accidents, including positioning a light source above a target area by extending a light structure to an extended position outward from a vehicle, turning off headlights of the vehicle, and illuminating the target area from above with the light source.

### CROSS-REFERENCE TO RELATED APPLICATION

This application claims the benefit of U.S. Provisional App. No. 63/478,312, filed Jan. 3, 2023, the entire disclosure of which is incorporated herein.

### STATEMENT OF GOVERNMENT LICENSE RIGHTS

This invention was made with Government support under Contract No. 6913G622C100009 awarded by the U.S. Department of Transportation. The Government has certain rights in the invention.

### BACKGROUND

The purpose of a vehicle's headlights is to illuminate the roadway for the driver and ensure that other drivers can identify the vehicle. While headlights identify vehicles, they also produce a glare for oncoming drivers and limit their ability to see within the vicinity of the headlights' source. One thing that causes this is that eyes adjust slowly when exposed to sudden changes in light, and this adaptation to light changes takes longer as age increases. It can take up to seven seconds for eyes to recover from the effect of headlight glare at night. Also, it is often painful for drivers to look directly at the high intensity light source of a headlight. This poses a problem for children that are boarding or disembarking school buses since they are walking in front of the headlights that drivers are trying to avoid looking at.

When children disembark a school bus, they sometimes must cross in front of the bus. This can result in dangerous situations when oncoming traffic is unable to see the children crossing. From the prospective of the bus driver, the children may be relatively well illuminated but from the prospective of a motorist approaching head-on, as children walk in front of the bus, as soon as children pass in front of the headlights on the bus, the children became virtually invisible. When a child walks in front of a headlight, the child becomes a silhouette and seems to disappear. This phenomenon is because the child is backlit by a very close and very bright headlight that is at the same level as the student. The combination of these factors prevents oncoming drivers from being able to see children crossing in front of the school bus. Once a child has crossed past the front of the school bus, the oncoming vehicle's lights are the only lights that illuminate the children crossing the road. This poses a problem when there could be up to 3 lanes that the student needs to cross in addition to the lane the school bus is in.

Additionally, from the prospective of a motorist approaching the bus from a cross-view or perpendicular to the direction of travel, the headlights on the bus may illuminate a child closest to the bus, but the children further from the bus are far less conspicuous.

Accordingly, methods and devices for illuminating children crossing in front of a bus are needed.

### SUMMARY

Disclosed herein is a lighting system configured to couple to a vehicle, the lighting system including a light source configured to illuminate a target area in front of the vehicle from above, where the lighting system is configured to move between a retracted position and an extended position.

In some embodiments, the lighting system further comprises a means of turning off headlights of the vehicle when the lighting system is in the extended position. In some embodiments, the means of turning off the headlights of the vehicle is selected from a single-pole double-throw (SPDT) automotive relay circuit coupled with headlights and a battery of the vehicle, a mechanical switch configured to interrupt power coupled with headlights and a battery of the vehicle, a sensor configured to communicate with a computer multiplex-based electrical system of the vehicle, or a combination thereof.

In some embodiments, the lighting system is coupled to a front bumper of the vehicle. In some embodiments, the lighting system is coupled to a roof of the vehicle. In some embodiments, the vehicle is a bus.

In some embodiments, the lighting system further comprises an actuator configured to control movement of the lighting system.

In some embodiments, the light source comprises a strip of light-emitting diodes (LEDs).

In some embodiments, the lighting system further includes a first flange located on a first side of the light source, and a second flange located on a second side, opposite the first side of the light source, where the first flange and the second flange are configured to direct light from the light source towards the target area.

In some embodiments, the lighting system further includes a support arm configured to position the light source, and a support beam configured to brace the support arm.

In some embodiments, the lighting system further includes a rail configured to guide the support arm between the extended position and the retracted position.

In some embodiments, the lighting system further includes a gear system configured to control movement of the lighting system, wherein the gear system includes a motor, a chain, a motor sprocket configured to drive the chain, and a sprocket configured to guide the chain around the rail, where, when the gear system is turned on, the chain moves around the rail, moving the support arm between the extended position and the retracted position.

In some embodiments, the lighting system further includes two support arms configured to position the light source, and two support beams configured to brace each support arm of the two support arms.

Also disclosed herein is a method of preventing accidents, including positioning a light source above a target area by extending the light structure described herein to an extended position outward from a vehicle, turning off headlights of the vehicle; and illuminating the target area from above with the light source.

In some embodiments, the method further includes blocking light from the light source with a first flange located on a first side of the light source and a second flange located on a second side of the light source.

In some embodiments, positioning the light source includes actuating an actuator to control the lighting system.

In some embodiments, turning off the headlights of the vehicle includes directing the headlights of the vehicle with a SPDT automotive relay circuit coupled with the headlights and a battery of the vehicle, interrupting power with a mechanical switch coupled with the headlights and the battery of the vehicle, or transmitting a sensed signal with a sensor configured to communicate with a computer multiplex-based electrical system of the vehicle.

Also disclosed herein is a method of using a lighting system including stopping a vehicle, putting the vehicle in neutral, applying a parking brake of the vehicle, opening a door of the vehicle to activate a stop arm of the vehicle, receiving a voltage trigger from the stop arm with a controller, disengaging a motor brake, positioning the lighting system coupled to the vehicle to an extended position over a target area, wherein the lighting system is configured to move between a retracted position and the extended position, engaging the motor brake, turning on a light source of the lighting system, and turning off headlights of the vehicle.

In some embodiments, the method includes turning off the vehicle, powering the controller with a battery of the vehicle, disengaging the motor brake, returning the lighting system to the retracted position, engaging the motor brake, and idling the motor.

In some embodiments, the method further includes closing the door of the vehicle, deactivating a voltage trigger from the stop arm with the controller, turning off the light source of the lighting system, turning on the headlights of the vehicle, returning the lighting system to the retracted position, engaging the motor brake, and idling the motor.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1A is a diagram of an underlying concept of an example lighting system, in accordance with the present technology;

FIG. 1B is an example lighting system in context, in accordance with the present technology;

FIG. 1C is an illustration of an underlying concept behind an example lighting system, in accordance with the present technology;

FIG. 2 is a perspective view of an example lighting apparatus, in accordance with the present technology;

FIG. 3A-3C show an example lighting system in operation, in accordance with the present technology;

FIG. 4 is a side-view of an example lighting system, in accordance with the present technology;

FIG. 5 is a top-down view of a vehicle with an example lighting system, in accordance with the present technology;

FIG. 6 is another example lighting system, in accordance with the present technology

FIG. 7 is another example lighting system with example measurements, in accordance with the present technology;

FIG. 8A is another example lighting system, in accordance with the present technology;

FIG. 8B is an example one or more flanges of a lighting system, in accordance with the present technology;

FIG. 8C is an example one or more flanges of a lighting system in operation, in accordance with the present technology;

FIG. 9 is an example red-line scan in accordance with the present technology;

FIGS. 10A-10F are yet another example lighting system 1100A, in accordance with the present technology

FIG. 11 is an example single-pole-double-throw (SPDT) relay circuit, in accordance with the present technology;

FIG. 12 is an example controller input/output (I/O), in accordance with the present technology;

FIG. 13 is an example method of preventing accidents, in accordance with the present technology;

FIG. 14 is an example startup method of a lighting system, in accordance with the present technology;

FIG. 15 is an example activation sequence of a lighting system, in accordance with the present technology; and

FIG. 16 is an example deactivation sequence of a lighting system, in accordance with the present technology.

### DETAILED DESCRIPTION

Disclosed herein is a lighting system configured to be coupled to a vehicle, the lighting system including a light source configured to illuminate a target area in front of a vehicle, where the lighting system is configured extend from the vehicle.

Though the present disclosure focuses on utilizing this lighting system with a school bus, the lighting system may be used with any vehicle, including but not limited to a public transit bus, a car, a truck, or the like.

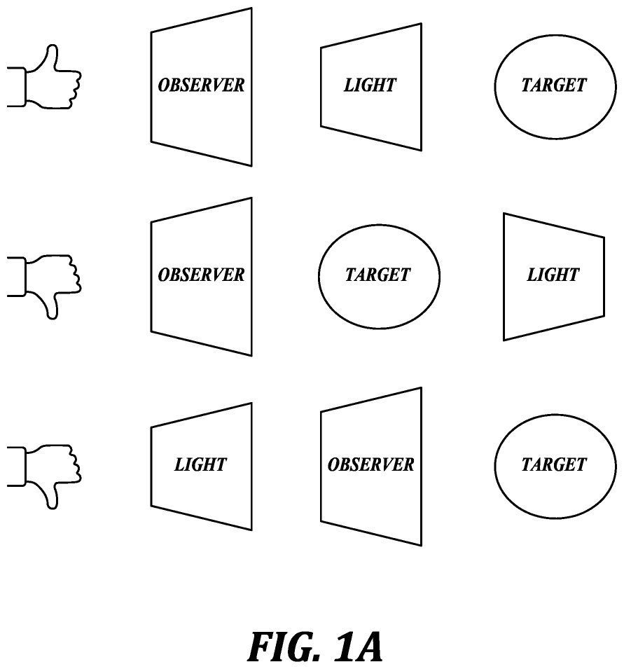

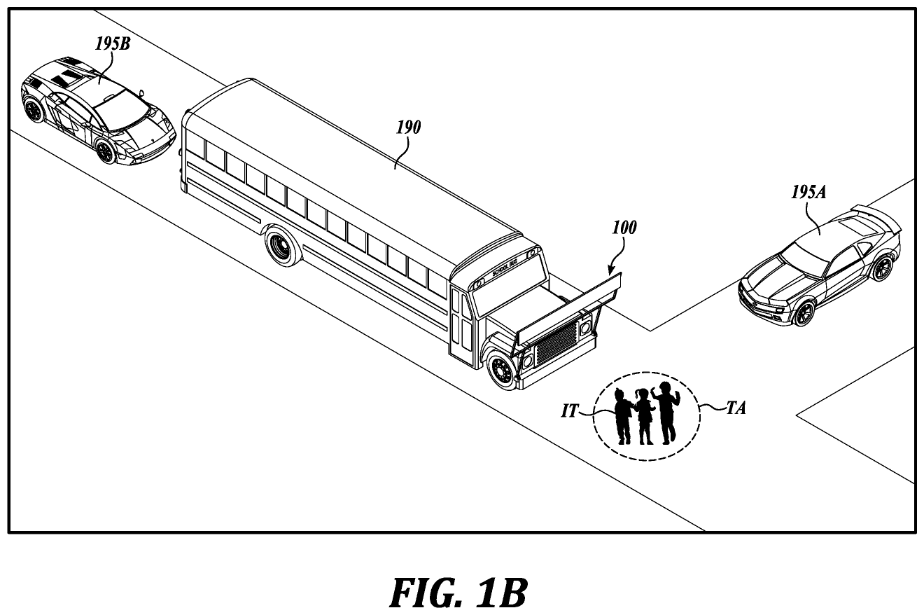

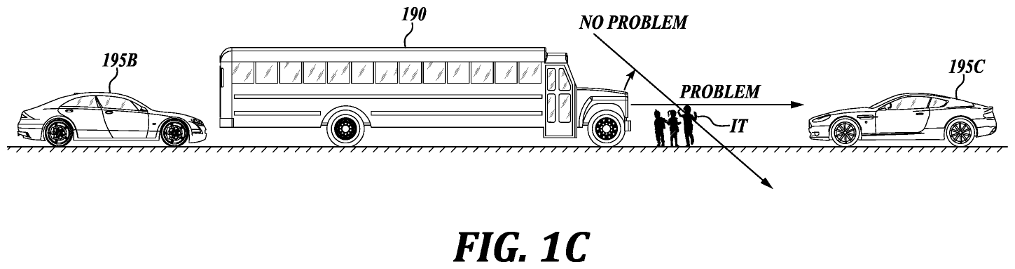

FIG. 1A is a diagram of an underlying concept of an example lighting system, in accordance with the present technology. When thinking about why the children appeared so well illuminated for the bus driver and virtually invisible to oncoming traffic, the inventors formed a hypothesis that if the light source is placed between the observer and the target, then the target can be easily detected by the observer. Conversely, if the light source is placed opposite the target and shone towards the observer, the observer cannot detect the target. Testing this hypothesis proved accurate, and a “rule” was established related to seeing the child in the roadway. When the observer was behind the light source, and the light source was between the observer and the target, the observer was able to see the target, as shown in the top row of FIG. 1A. When the observer was behind the target and the light source was on a side opposite the observer, the resulting glare made the target difficult to see, as shown in the middle row in FIG. 1A. When the observer was between the target and the light source, the resulting glare made the target difficult to see as well, as shown in the bottom row of FIG. 1A To see the target, an observer is positioned behind the light source, with the light source between the observer and the target. This allows for the observer to see the target without being blinded by the lights.

FIG. 1B is an example light structure 100 in context, in accordance with the present technology. It was determined that adding a light source virtually anywhere on the bus created value for one observer's viewpoint while creating an inverse proportionally negative result for another observer's view position. In one experiment, a light to the upper side of the bus above the driver's side window was added. This increased light around the scene generally but created a hazard as the driver approaching from the side could not see the child (experienced glare at a minimum). In another experiment, that light source was moved forward 45 degrees, which created glare in the crosswalk mirrors bouncing back into the eyes of the bus driver, as well as added glare for oncoming traffic and cross view traffic. In another experiment, as shown in FIG. 1B, the same light source was moved “out” over the front of the bus 190 and an immediate improvement in perception was observed when the light was shining “down” on top of the children (or illumination target) IT in a target area TA.

The direction of light was changed, so that the children were illuminated from above light like a streetlamp. This prevents the drivers from being affected by glare and removes the backlit phenomenon. Disclosed herein is a light bar that attaches to the top of the school bus and slides out above the children to illuminate them from above. When the lighting apparatus is activated, it turns off the bus headlights to prevent glare, and turns on the downward facing light to illuminate across multiple lanes of traffic. Since it is shining down there is no glare for the driver, and the driver can still identify the bus from the running lights and flashing hazard lights.

When the lighting system 100 was positioned over the children IT, all three observers (the bus 190, a first car 195A, and a second car 195B were able to see the children without adverse glare.

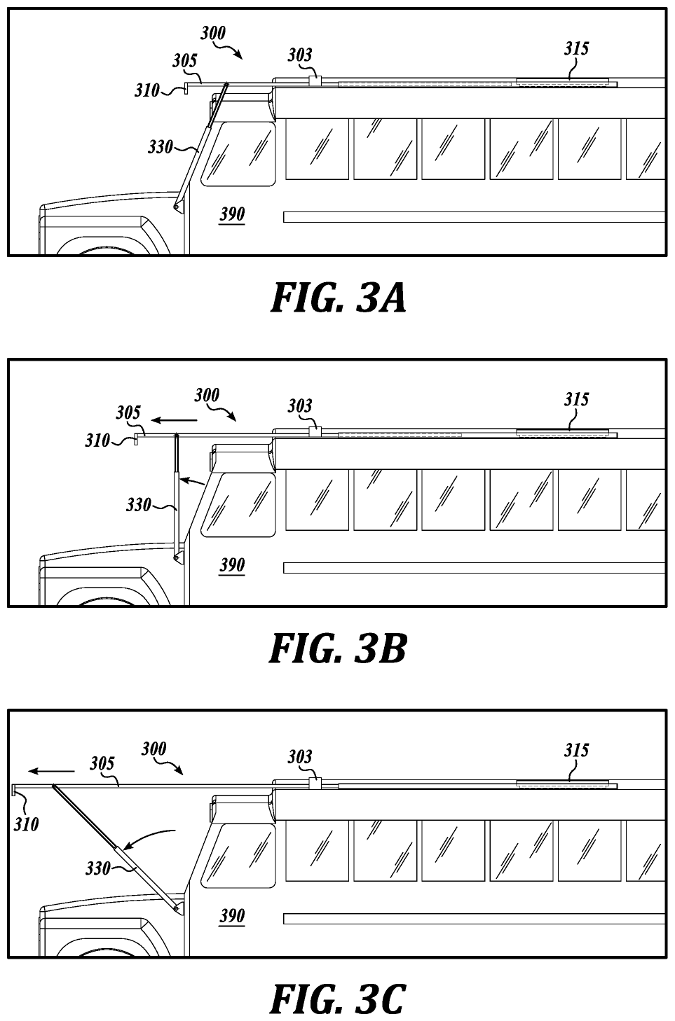

FIG. 3 is an illustration of an underlying concept behind an example lighting system, in accordance with the present technology. When trying to figure out why the light shining slightly “down” on the top of the kids prevented glare, the rule established above in FIG. 1A was considered. In order to see the target, the light source has to be between the observer and the target, and not directly in the view of the observer. The only position an observer is not located in this scenario was below the child. As such, a light above the child's head shining on the ground does not create glare for any observer (such as bus 190, first car 195A, and second car 190B). The light reflected off the child can be observed in any position of observer, similar to the rule above in FIG. 1A (observer>light>target).

While brainstorming a solution, inspiration was taken from the fire structure “compartment” light world, and a linear extruded strip light was built to hang over the children's heads. It was then attached to 2 photo light stands that were suspended about 6′ off the ground. In some embodiments, a rack mechanism is included and configured to attach to the front of the bus 190 and mechanically articulate out to hang a lightweight light source overhead. Examples of such lighting systems are illustrated and described herein.

When the light was on, the bus headlights may still produce glare for oncoming motorists. Accordingly, in some embodiments, a single-pole-double-throw (SPDT) relay is included to a limit switch on this conceptual “rack”, that would allow the bus headlights to turn “off” when the rack was deployed, then back “on” when it was stowed. Examples of such SPDT relays are shown and described herein. To test this, the headlights were “off” while the light on the stands “on”. Further, by breaking the angle of projection from horizontal to vertical (shining “down” vs “out”), the glare issue is resolved, and the improved child visibility may still be achieved.

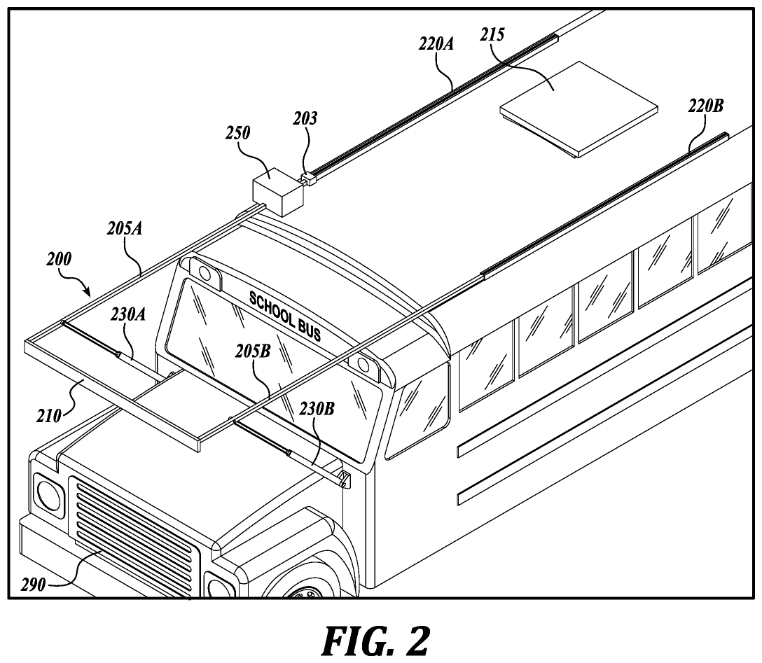

FIG. 2 is a perspective view of an example lighting system 200, in accordance with the present technology. In some embodiments, the lighting system 200 is a “sled” configured to slide in front of a vehicle 290. In some embodiments, the vehicle 290 is a bus, but the vehicle 290 may be any vehicle, including but not limited to a car, truck, or the like. As shown in FIG. 2, the sledge lighting system 200 may include one or more support beams 205A, 205B, one or more support arms 230A, 230B, one or more tracks 220A, 220B, a light source 210, a cart 203, and a motor 250. In some embodiments, such as when the vehicle 290 is a bus, the vehicle 290 may include an escape hatch 215. When the lighting system 200 is attached to the vehicle 290, this escape hatch 215 is still accessible. In some embodiments, the one or more support beam 230A, 230B is moved in front of the vehicle when the cart 203 slides along the track 220A, 220B, as shown in FIGS. 3A-3B.

FIGS. 3A-3C show an example lighting system 300 in operation, in accordance with the present technology. In some embodiments, the lighting system 300 is lighting system 200 of FIG. 2. It should be understood by one skilled in the art that components of the lighting system 200 have been omitted for clarity. In some embodiments, the lighting system 200 includes a support beam 330, a support arm 305, and a cart 303. In some embodiments, the lighting system 300 is attached to a vehicle 390 having an escape hatch 315. In some embodiments, the escape hatch 315 remains accessible throughout the entire operation illustrated in FIGS. 3A-3C.

In FIG. 3A, the lighting system 300 is in an “off” or “retracted” position. In the off position, the support arm 305 rests on the top of the vehicle 390. The support beam 330 is located on an edge of the front window of the vehicle 390.

In FIG. 3B, the lighting system 300 moves when activated by a motor (such as motor 250 in FIG. 2). The cart 303 moves the support arm 305 out in front of the vehicle 390. Further, the support beam 330 straightens to assist the support arm 305.

In FIG. 3C, the lighting system 300 is in an “on” or “extended” position. In the on position, the support arm 305 extends a light source (such as light source 210) out in front of the vehicle to illuminate a target area (such as target area TA in FIG. 1B) in front of the vehicle 390.

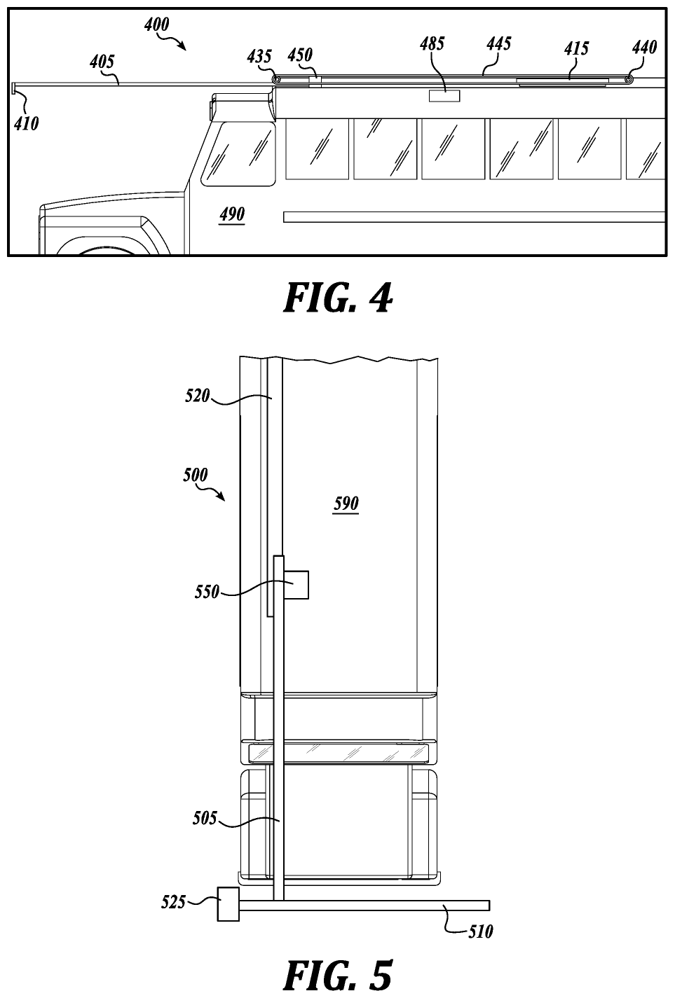

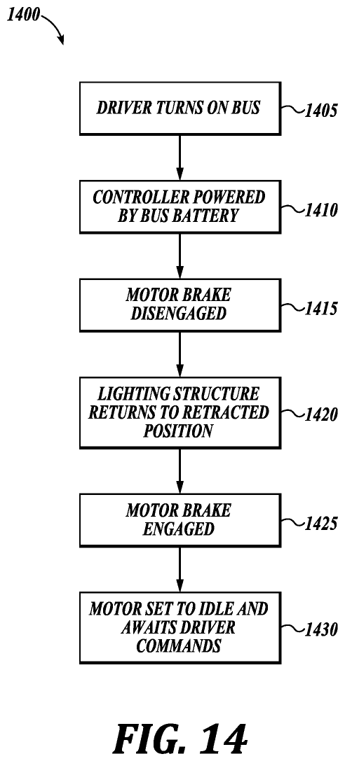

FIG. 4 is a side-view of an example lighting system 400, in accordance with the present technology. In some embodiments, the lighting system 400 further includes a sprocket 440, a motor sprocket 435, and chain 445 coupled with a motor 450. In some embodiments, the chain 445 is connected to both the motor sprocket 435 and the sprocket 440. When the motor 450 moves the motor sprocket 435, the chain 445 moves around the sprocket 440 and the motor sprocket 435 to slide the lighting support arm 405 in front of the vehicle 490. In some embodiments, the vehicle 490 further includes a controller 485. The controller may direct the vehicle 490 and/or the lighting system 400, as explained in detail in FIGS. 14, and 16-18.

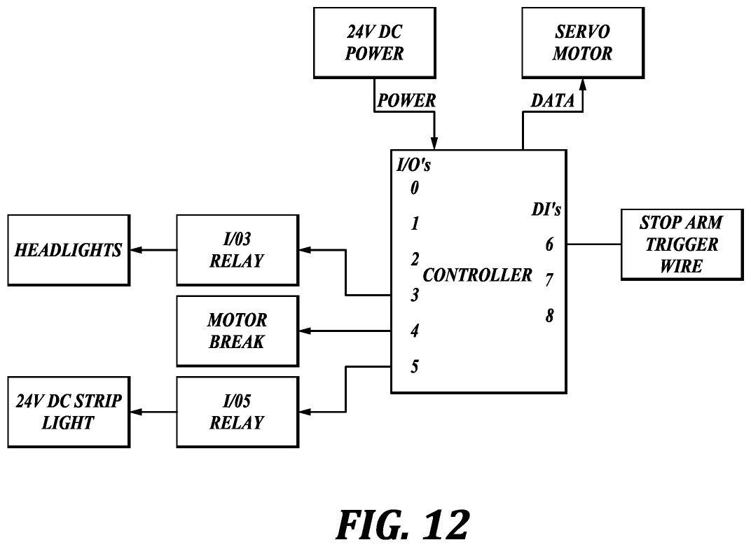

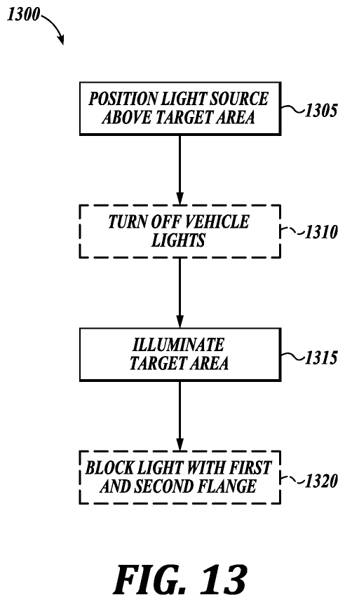

In some embodiments, the lighting system 400 is further configured to turn off lights of the vehicle 490 it is coupled to. In some embodiments the lighting system 400 further includes a single-pole double-throw (SPDT) automotive relay circuit (as shown and described in FIGS. 12-13) coupled with headlights and a battery of the vehicle 490 and configured to turn off the headlights of the vehicle 490 when the lighting system 400 extends from the vehicle. In some embodiments, the lighting system 400 includes a mechanical switch (not shown in FIG. 4). In operation, the mechanical switch can interrupt power to the headlights of the vehicle 490. In some embodiments, the lighting system 400 includes a sensor (not shown in FIG. 4) configured to communicate with a computer multiplex-based electrical system of the lighting system 400 or the vehicle 490, in order to turn off the headlights of the vehicle. It should be understood that the mechanical switch and/or sensor may be located anywhere on the vehicle 490 or the lighting system 400, and operation of the sensor and/or mechanical switch is shown and described in FIGS. 13-14.

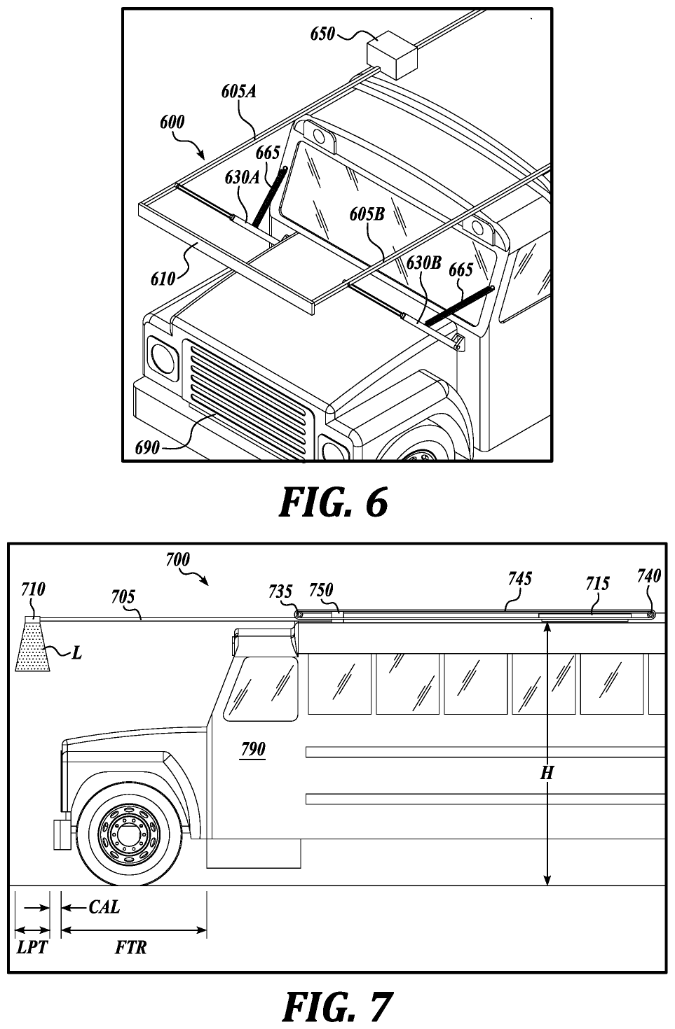

FIG. 5 is a top-down view of a vehicle 590 with an example lighting system 500, in accordance with the present technology. In some embodiments, the lighting system 500 is a rack lighting system, including a single support beam 505 and a counterweight 525. In some embodiments, the counterweight 525 is configured to balance the lighting system 500. The counterweight 525 may be attached to a light source 510. In this manner the light source 510 can illuminate a target area (such as target area TA in FIG. 1B) in front of the vehicle 590.

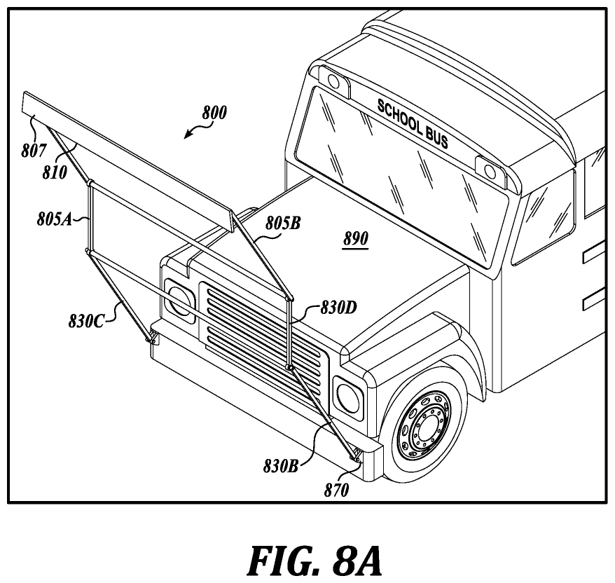

FIG. 6 is another example lighting system 600, in accordance with the present technology. In some embodiments, lighting system 600 includes one or more support arms 605A, 605B, one or more support beams 630A, 630B, a motor 650, and a light source 610. In some embodiments, the lighting system 600 further includes a tortional spring 660 and a linear spring 665. As the one or more support arms 605A, 605B extend in front of a vehicle 690, the tortional spring 660 allows for the one or more support arms 630A, 630B to support the one or more support arms 605A, 605B. Similarly, the linear spring 665 allows for the one or more support beams 630A, 630B to transition from a retracted to an extended position of the lighting system 600 (as shown in FIGS. 3A-3C), and back.

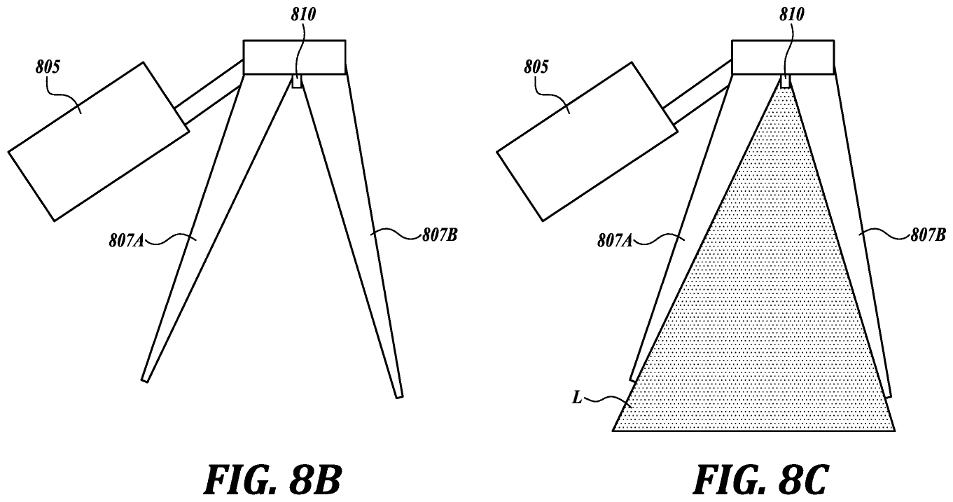

FIG. 7 is another example lighting system 700 with example measurements, in accordance with the present technology. In some embodiments, the lighting system 700 includes a support beam 705, a light source 710 configured to emit light L, sprocket 740, a motor sprocket 735, and chain 745 coupled with a motor 750. In some embodiments, the length of the support structure, that is from the sprocket 740 to the light source 710, when extended, is about 14 feet. In some embodiments, a length to a pathway, or target area, LTP is about 2.5 feet. In some embodiments, a crossing arm length CAL is about 6 feet, and the distance from a front of the vehicle 790 to the roof FTR is about 6.5 feet. In some embodiments, the vehicle 290 has a height H of about 10.2 feet tall.

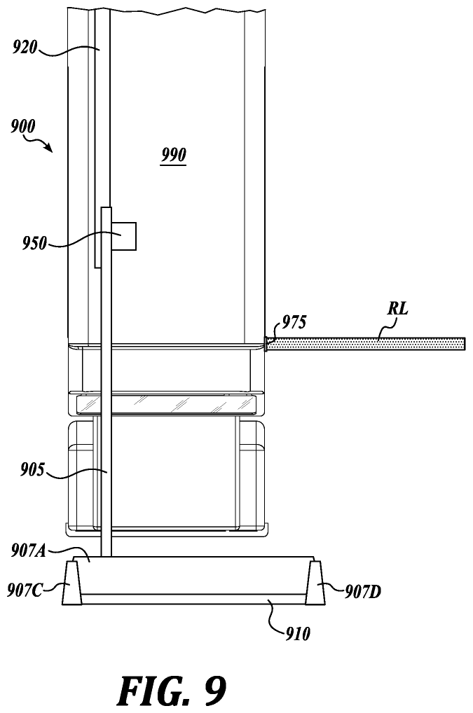

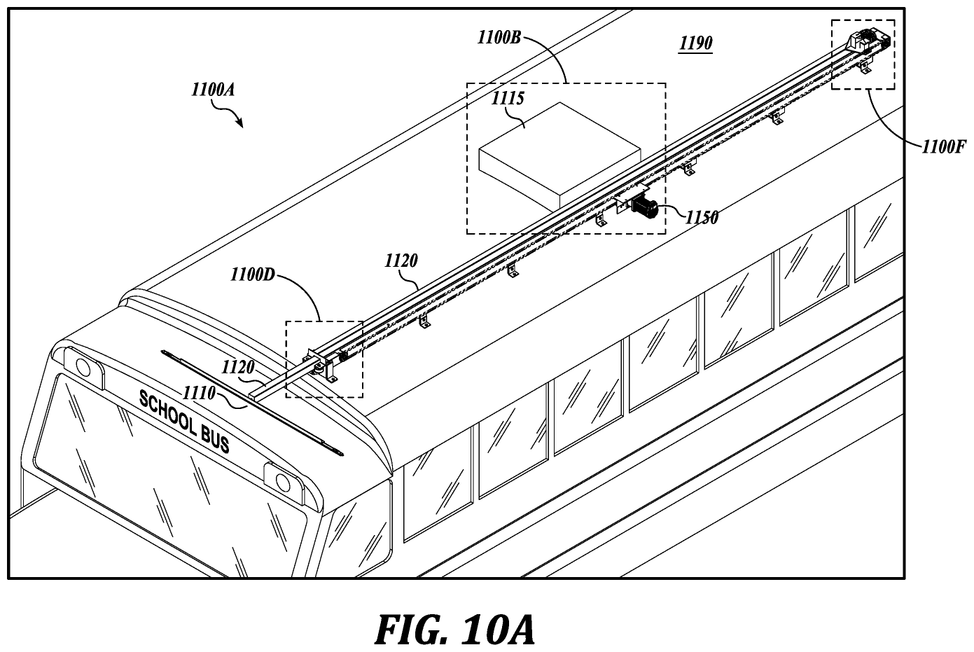

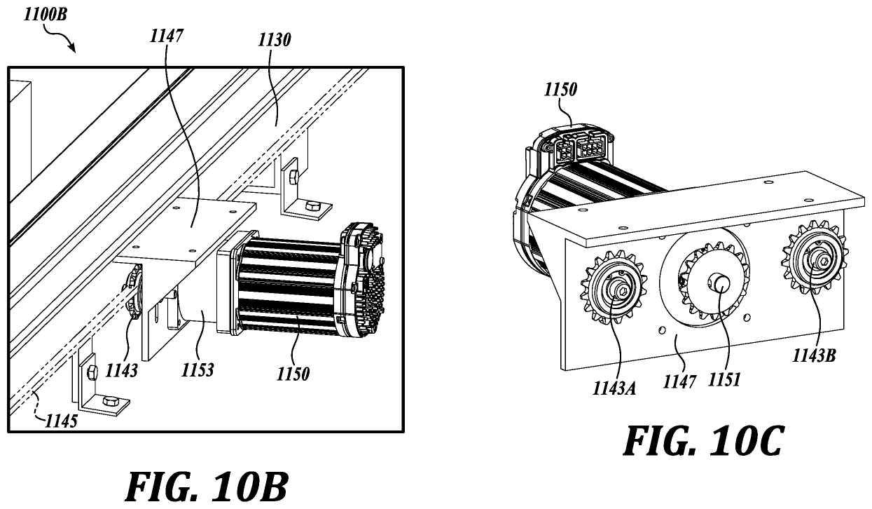

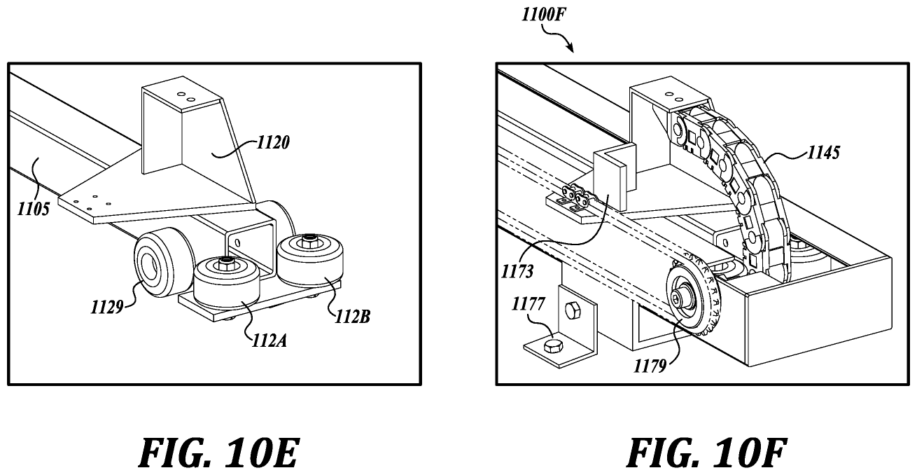

FIG. 8A is another example lighting system 800, in accordance with the present technology. In some embodiments, the lighting system 800 includes a first set of support beams 830A, 830B coupled to the vehicle 890, a second set of support beams 830C, 830D configured to increase a height of the light source 810, and a set of support arms 805A, 805B coupled to the light source 810 and configured to extend the light source 810 in front of the vehicle 890, as shown in FIG. 10. In some embodiments, the light structure 800 is located on a front bumper of the vehicle 890.

In some embodiments, the lighting system further comprises an actuator 870 configured to control movement of the lighting system 800. In some embodiments, the actuator 870 is located at the base of the lighting system 800. In some embodiments, the actuator 870 is configured to pneumatically control the movement of the lighting system 800. In some embodiments, the actuator 870 is configured to electrically control the movement of the lighting system 800. In some embodiments, the light source 810 comprises an LED strip light. In some embodiments, the lighting system 800 includes one or more flanges 807, configured to shield the light source 810.

FIG. 8B is an example one or more flanges 807A, 807B of a lighting system, in accordance with the present technology. In some embodiments, the lighting system 800 includes a first flange 807A and a second flange 807B. In some embodiments, the first flange 807A is located on a first side of the light source 810 and the second flange 807B is located on a second side of the light source 810. In some embodiments, the lighting system 800 further includes a first end flange located on a third side of the light source, and a second end flange located on a fourth side, opposite the third side of the light source 810, where the first end flange and the second end flange are configured to further direct the light from the light source into the area in front of the vehicle 890. In such embodiments, the light source 810 may be surrounded by flanges 807.

FIG. 8C shows the first flange 807A and the second flange 807B in operation, in accordance with the present invention. As shown in FIG. 8C, in some embodiments, the flanges 807A, 807B are disposed at an angle, so that the first and second flange 807A, 807B shield the light source 810 and direct the light source's illumination (light L) towards the target area in front of the vehicle 890.

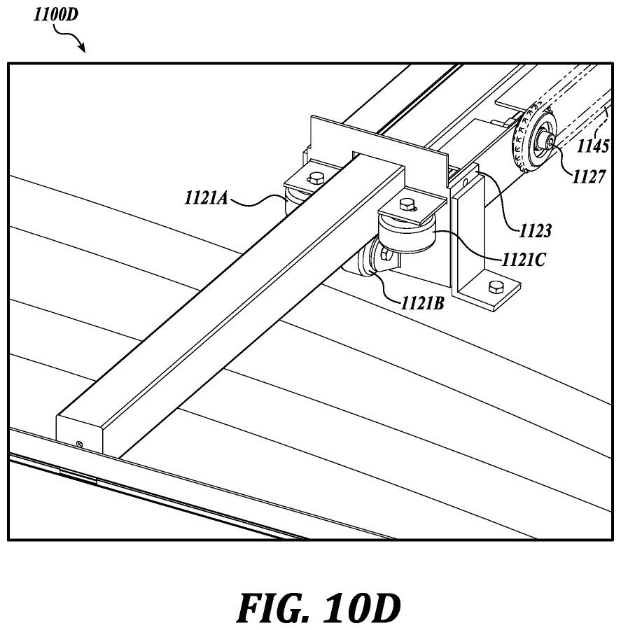

FIG. 9 is an example red-line scan in accordance with the present technology. In some embodiments, the lighting system 1000 is further configured to emit a red line RL from a red line scan light 1075 to further prevent accidents. In operation, the red line scan light 1075 is configured to project a red line RL, as shown in FIG. 13. In some embodiments, the red line scan light 1075 is mounted at about a 45-degree angle on a driver's side mirror of the vehicle 1090.

FIGS. 10A-10F are yet another example lighting system 1100A, in accordance with the present technology. FIG. 10A shows a full view of the lighting system 1100A. In some embodiments, the lighting system 1100A includes a cantilever arm 1105, a light source 1110, a guide rail 1120, and a motor 1150. In some embodiments, the lighting system 1100 is coupled to the roof of a vehicle 1190. In some embodiments, the vehicle 1190 includes an escape hatch 1115. In some embodiments, the escape hatch 1115 remains accessible, even when the lighting system 1100A is coupled to the vehicle 1190. Multiple areas of the lighting system 1100A are marked with boxes 1100B, 1100D, and 1100F. Close up views of these components are shown in FIGS. 10B, 10D, and 10F respectively.

FIG. 10B is a close-up view of the box 1100B in FIG. 10A. In some embodiments, the lighting system 1100A includes an idle sprocket 1143, a chain 1145, a motor brake 1153, and a motor 1150. In some embodiments, the motor is coupled to a rail 1130 with a motor mount 1147. FIG. 10C shows a backside of the motor mount 1147. The motor mount 1147 connects the motor 1150 to the rail 1130. Tensioner sprockets 1143A, 1143B interact with the idle sprocket 1143 to allow the chain 1145 to pass by the motor mount 1147. Power is supplied to a drive sprocket 1151 to move the chain in response to the motor 1150. In some embodiments, the drive sprocket 1151 is the motor sprocket 440, 740 described herein. In this manner, the motor 1150 may drive the lighting system 1100A to move from an extended position to a retracted position, and back.

FIG. 10D is a close-up view of the box 1100C in FIG. 10A. In some embodiments, the lighting system 1100A includes a rail 1120 including a roller guide frame 1123, one or more guide rollers 1121A, 1121B, 1121C, and a front sprocket 1127. In some embodiments, the front sprocket 1127 may be the sprocket 435, 735 described herein. FIG. 10E is a view of the cantilever arm 1120 interacting with the guide rollers 1121A, 1121B and the rail 1120. In some embodiments, the rail 1120 further includes an internal wheel 1129 configured to assist the cantilever arm 1120 in extending and retracting.

FIG. 10F is a close-up view of the box 1100F in FIG. 10A. In some embodiments, the lighting system 1100A includes a back end 1100F including a chain 1145, a drive chain mount 1189, a rear sprocket 1179, a rear end stop 1173, and a roof mount 1177. As shown in FIGS. 10A-10F, any number of roof mounts 1177 may be incorporated into lighting system 1100A to attach the lighting system 1100A to the roof of the vehicle 1190.

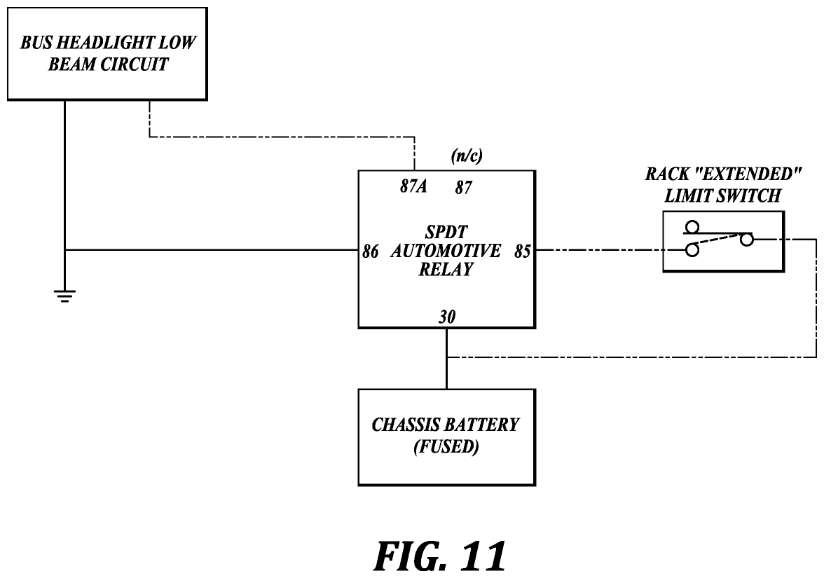

FIG. 11 is an example single-pole-double-throw (SPDT) relay circuit, in accordance with the present technology. It should be understood that the SPDT relay circuit shown may be incorporated into any of the lighting systems disclosed herein. In some embodiments, the lighting system is further configured to turn off headlights of the vehicle. In some embodiments, the circuit may be an electronically operated switch. In some embodiments, the circuit may be an automotive relay.

FIG. 12 is an example controller input/output (I/O), in accordance with the present technology. In some embodiments, the lighting system includes a controller coupled with the headlights of the vehicle, the motor break of the vehicle, and the light source (for example a 24V direct current (DC) strip light) of the lighting system. In some embodiments, the controller may also be coupled with the stop arm trigger wire of a built-in stop sign (such as when the vehicle is a school bus).

In operation, the controller receives power from a 24V DC power source. The stop arm trigger wire may transmit data to the controller, which then operates the headlights, motor break, and/or 24V DC strip light. In some embodiments, when the vehicle is stopped, put in neutral, and the parking brake is employed, a door of the vehicle can be opened to activate a stop arm of the vehicle. The controller then receives a voltage trigger from the stop arm. The controller may then disengage the motor brake of the vehicle and position the lighting system coupled to the vehicle to an extended position over a target area. Then the controller engages the motor brake and turns on a light source (the 24V DC strip light) of the lighting system. In some embodiments, the controller may also turn off the headlights of the vehicle.

In some embodiments, the controller may perform a start-up process. In some embodiments, the start-up process may be performed any time the vehicle is turned on. When the vehicle is turned on, the controller may be powered with a battery of the vehicle. A driver or user of the vehicle may then disengage the motor brake, return the lighting system to the retracted position, engage the motor brake, and idle the motor. In some embodiments, the controller returns the lighting system to the retracted position.

In some embodiments, the controller may also perform a shut-down (or deactivation) process. In some embodiments, the shut-down process occurs anytime the lighting system is returned to the retracted position. In operation, a driver or user may close the door of the vehicle, deactivating a voltage trigger from the stop arm with the controller. The controller may then turn off the light source of the lighting system, turn on the headlights of the vehicle, return the light source to the retracted position; engage the motor brake, and idle the motor.

FIG. 13 is an example method 1300 of preventing accidents, in accordance with the present technology. In another aspect, disclosed herein is a method of preventing accidents. In some embodiments, the method is carried out with any of the lighting systems 100, 200, 300, 400, 500, 600, 700, 800, 900, 1100 disclosed herein. In some embodiments, the lighting system may further include a controller coupled with the lighting system and the headlights of the vehicle.

In block 1305, a light source (such as light source 210, 310, 410, 510, 610, 710, 810, 910, 1110) is positioned above a target area (such as target area TA). In some embodiments, positioning the light source includes actuating an actuator to control the lighting system. In some embodiments, the actuator is located at the base of the lighting system. In some embodiments, positioning the light source further comprises pneumatically controlling movement of the lighting system. In some embodiments, positioning the light source further comprises electrically controlling movement of the lighting system.

In block 1310, optionally, the headlights of the vehicle are turned off. In some embodiments, turning off the headlights of the vehicle comprises providing a SPDT automotive relay circuit coupled with the headlights and a battery of the vehicle. In some embodiments, turning off the headlights of the vehicle includes directing the headlights of the vehicle with a SPDT automotive relay circuit coupled with the headlights and a battery of the vehicle, interrupting power with a mechanical switch coupled with the headlights and the battery of the vehicle, or transmitting a sensed signal with a sensor configured to communicate with a computer multiplex-based electrical system of the vehicle.

In block 1315, the target area is illuminated.

In block 1320, optionally, light from the light source may be blocked with a first flange (such as first flange 807A, 907A) and a second flange (such as second flange 807B).

FIG. 14 is an example startup method 1400 of a lighting system, in accordance with the present technology. In some embodiments, the method is carried out with any of the lighting systems 100, 200, 300, 400, 500, 600, 700, 800, 900, 1100 disclosed herein. In some embodiments, the lighting system may further include a controller coupled with the lighting system and the headlights of the vehicle, such as shown in FIG. 12.

In block 1405, a driver of the vehicle (or user) turns on the vehicle (referred to in FIG. 14 as a bus). In some embodiments, the vehicle is a bus, such as a school bus, with a stop arm configured to extend a stop sign, to stop oncoming traffic while passengers are crossing.

In block 1410, the controller is powered by the battery of the bus. In some embodiments, the controller is electrically coupled to the battery of the bus, headlights of the bus, the stop arm of the bus, a light source of the lighting system, and/or the motor brake of the bus. In some embodiments, the controller may further be coupled to a servo motor.

In block 1415, the controller disengages the motor brake of the bus.

In block 1420, the lighting apparatus (or lighting system) returns to the retracted position, as described herein. In some embodiments, block 1415 and block 1420 occur simultaneously.

In block 1425, the controller engages the motor brake of the bus.

In block 1430, the motor is set to idle. The controller awaits driver commands, such as to extend the stop arm, move the lighting system into the extended position as described herein, and the like.

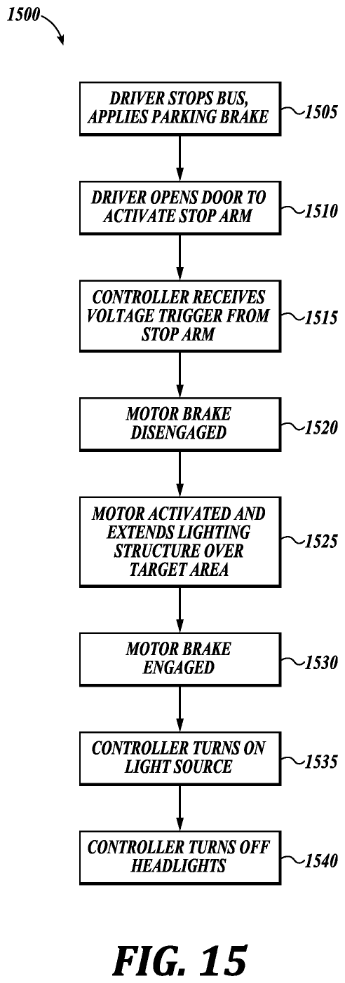

FIG. 15 is an example activation sequence of a lighting system, in accordance with the present technology. In some embodiments, the method is carried out with any of the lighting systems 100, 200, 300, 400, 500, 600, 700, 800, 900, 1100 disclosed herein. In some embodiments, the lighting system may further include a controller coupled with the lighting system and the headlights of the vehicle, such as shown in FIG. 12.

In block 1505, the driver stops the vehicle (referred to in FIG. 15 as a bus) and applies the parking brake.

In block 1510, the driver opens a door of the bus the activate the stop arm as described herein. In some embodiments, the stop arm transmits a voltage trigger to the controller.

In block 1515, the controller receives the voltage trigger from the stop arm. The controller may use this trigger to activate (or extend) the lighting system.

In block 1520, the motor brake of the bus is engaged.

In block 1525, a motor (such as motor 250, 450, 550, 650, 750) is activated, and it extends the lighting system over a target area (such as target area TA). In some embodiments, this extension is called the extension position, as illustrated in FIG. 3C. In block 1530, the motor brake of the bus is engaged.

In block 1535, the controller turns on the light source of the lighting system. In some embodiments, this is done with a relay, as shown in FIG. 12.

In block 1540, the controller turns off the headlights. This may also be done with a relay as shown in FIG. 12.

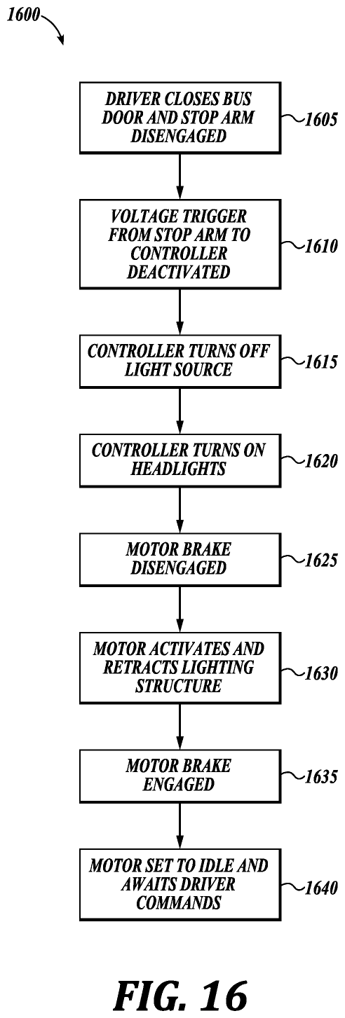

FIG. 16 is an example deactivation sequence 1600 of a lighting system, in accordance with the present technology. In some embodiments, the method is carried out with any of the lighting systems 100, 200, 300, 400, 500, 600, 700, 800, 900, 1100 disclosed herein. In some embodiments, the lighting system may further include a controller coupled with the lighting system and the headlights of the vehicle, such as shown in FIG. 12.

In block 1605, the driver closes a door of the bus to disengage the stop arm as described herein. In some embodiments, disengaging the stop arm deactivates the voltage trigger to the controller. In block 1610, the controller stops receiving the voltage trigger from the stop arm.

In block 1615, the controller turns off the light source of the lighting system. In some embodiments, this is done with a relay, as shown in FIG. 12 In block 1620, the controller turns on the headlights. This may also be done with a relay as shown in FIG. 12. In some embodiments, blocks 1615 and 1620 may be performed simultaneously.

In block 1625, the motor brake of the bus is disengaged. In block 1630, a motor (such as motor 250, 450, 550, 650, 750) is activated, and it retracts the lighting system back into a retracted position, as shown in FIG. 3A. In block 1635, the motor brake is engaged.

In block 1640, the motor is set to idle and awaits further commands from a driver or user of the bus.

It should be understood that all methods 1300, 1400, 1500, 1600 should be interpreted as merely representative. In some embodiments, process blocks of all methods 1300, 1400, 1500, 1600 may be performed simultaneously, sequentially, in a different order, or even omitted, without departing from the scope of this disclosure.

The present application may also reference quantities and numbers. Unless specifically stated, such quantities and numbers are not to be considered restrictive, but representative of the possible quantities or numbers associated with the present application. Also, in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A, B, and C,” for example, means (A), (B), (C), (A and B), (A and C), (B and C), or (A, B, and C), including all further possible permutations when greater than three elements are listed.

Embodiments disclosed herein may utilize circuitry in order to implement technologies and methodologies described herein, operatively connect two or more components, generate information, determine operation conditions, control an appliance, device, or method, and/or the like. Circuitry of any type can be used. In an embodiment, circuitry includes, among other things, one or more computing devices such as a processor (e.g., a microprocessor), a central processing unit (CPU), a digital signal processor (DSP), an application-specific integrated circuit (ASIC), a field-programmable gate array (FPGA), or the like, or any combinations thereof, and can include discrete digital or analog circuit elements or electronics, or combinations thereof.

In an embodiment, circuitry includes one or more ASICs having a plurality of predefined logic components. In an embodiment, circuitry includes one or more FPGA having a plurality of programmable logic components. In an embodiment, circuitry includes hardware circuit implementations (e.g., implementations in analog circuitry, implementations in digital circuitry, and the like, and combinations thereof). In an embodiment, circuitry includes combinations of circuits and computer program products having software or firmware instructions stored on one or more computer readable memories that work together to cause a device to perform one or more methodologies or technologies described herein. In an embodiment, circuitry includes circuits, such as, for example, microprocessors or portions of microprocessor, that require software, firmware, and the like for operation. In an embodiment, circuitry includes an implementation comprising one or more processors or portions thereof and accompanying software, firmware, hardware, and the like. In an embodiment, circuitry includes a baseband integrated circuit or applications processor integrated circuit or a similar integrated circuit in a server, a cellular network device, other network device, or other computing device. In an embodiment, circuitry includes one or more remotely located components. In an embodiment, remotely located components are operatively connected via wireless communication. In an embodiment, remotely located components are operatively connected via one or more receivers, transmitters, transceivers, or the like.

An embodiment includes one or more data stores that, for example, store instructions or data. Non-limiting examples of one or more data stores include volatile memory (e.g., Random Access memory (RAM), Dynamic Random Access memory (DRAM), or the like), non-volatile memory (e.g., Read-Only memory (ROM), Electrically Erasable Programmable Read-Only memory (EEPROM), Compact Disc Read-Only memory (CD-ROM), or the like), persistent memory, or the like. Further non-limiting examples of one or more data stores include Erasable Programmable Read-Only memory (EPROM), flash memory, or the like. The one or more data stores can be connected to, for example, one or more computing devices by one or more instructions, data, or power buses.

In an embodiment, circuitry includes one or more computer-readable media drives, interface sockets, Universal Serial Bus (USB) ports, memory card slots, or the like, and one or more input/output components such as, for example, a graphical user interface, a display, a keyboard, a keypad, a trackball, a joystick, a touch-screen, a mouse, a switch, a dial, or the like, and any other peripheral device. In an embodiment, circuitry includes one or more user input/output components that are operatively connected to at least one computing device to control (electrical, electromechanical, software-implemented, firmware-implemented, or other control, or combinations thereof) one or more aspects of the embodiment.

In an embodiment, circuitry includes a computer-readable media drive or memory slot configured to accept signal-bearing medium (e.g., computer-readable memory media, computer-readable recording media, or the like). In an embodiment, a program for causing a system to execute any of the disclosed methods can be stored on, for example, a computer-readable recording medium (CRMM), a signal-bearing medium, or the like. Non-limiting examples of signal-bearing media include a recordable type medium such as any form of flash memory, magnetic tape, floppy disk, a hard disk drive, a Compact Disc (CD), a Digital Video Disk (DVD), Blu-Ray Disc, a digital tape, a computer memory, or the like, as well as transmission type medium such as a digital and/or an analog communication medium (e.g., a fiber optic cable, a waveguide, a wired communications link, a wireless communication link (e.g., transmitter, receiver, transceiver, transmission logic, reception logic, etc.). Further non-limiting examples of signal-bearing media include, but are not limited to, DVD-ROM, DVD-RAM, DVD+RW, DVD-RW, DVD-R, DVD+R, CD-ROM, Super Audio CD, CD-R, CD+R, CD+RW, CD-RW, Video Compact Discs, Super Video Discs, flash memory, magnetic tape, magneto-optic disk, MINIDISC, non-volatile memory card, EEPROM, optical disk, optical storage, RAM, ROM, system memory, web server, or the like.

The detailed description set forth above in connection with the appended drawings, where like numerals reference like elements, are intended as a description of various embodiments of the present disclosure and are not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result. Generally, the embodiments disclosed herein are non-limiting, and the inventors contemplate that other embodiments within the scope of this disclosure may include structures and functionalities from more than one specific embodiment shown in the figures and described in the specification.

In the foregoing description, specific details are set forth to provide a thorough understanding of exemplary embodiments of the present disclosure. It will be apparent to one skilled in the art, however, that the embodiments disclosed herein may be practiced without embodying all the specific details. In some instances, well-known process steps have not been described in detail in order not to unnecessarily obscure various aspects of the present disclosure. Further, it will be appreciated that embodiments of the present disclosure may employ any combination of features described herein.

The present application may include references to directions, such as “vertical,” “horizontal,” “front,” “rear,” “left,” “right,” “top,” and “bottom,” etc. These references, and other similar references in the present application, are intended to assist in helping describe and understand the particular embodiment (such as when the embodiment is positioned for use) and are not intended to limit the present disclosure to these directions or locations.

The present application may also reference quantities and numbers. Unless specifically stated, such quantities and numbers are not to be considered restrictive, but exemplary of the possible quantities or numbers associated with the present application. Also, in this regard, the present application may use the term “plurality” to reference a quantity or number. In this regard, the term “plurality” is meant to be any number that is more than one, for example, two, three, four, five, etc. The term “about,” “approximately,” etc., means plus or minus 5% of the stated value. The term “based upon” means “based at least partially upon.”

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

While illustrative embodiments have been illustrated and described, it will be appreciated that various changes can be made therein without departing from the spirit and scope of the invention.

1. A lighting system configured to couple to a vehicle, the lighting system comprising:
a light source configured to illuminate a target area in front of the vehicle from above, wherein the lighting system is configured to move between a retracted position and an extended position.

2. The lighting system of claim 1, further comprising a means of turning off headlights of the vehicle when the lighting system is in the extended position.

3. The lighting system of claim 2, wherein the means of turning off the headlights of the vehicle is selected from a single-pole double-throw (SPDT) automotive relay circuit coupled with headlights and a battery of the vehicle, a mechanical switch configured to interrupt power coupled with headlights and a battery of the vehicle, a sensor configured to communicate with a computer multiplex-based electrical system of the vehicle, or a combination thereof.

4. The lighting system of claim 1, wherein the lighting system is coupled to a front bumper of the vehicle.

5. The lighting system of claim 1, wherein the lighting system is coupled to a roof of the vehicle.

6. The lighting system of claim 1, wherein the vehicle is a bus.

7. The lighting system of claim 1, further comprising an actuator configured to control movement of the lighting system.

8. The lighting system of claim 1, wherein the light source comprises a strip of light-emitting diodes (LEDs).

9. The lighting system of claim 1, further comprising:
a first flange located on a first side of the light source; and
a second flange located on a second side, opposite the first side of the light source,
wherein the first flange and the second flange are configured to direct light from the light source towards the target area.

10. The lighting system of claim 1, further comprising:
a support arm configured to position the light source; and
a support beam configured to brace the support arm.

11. The lighting system of claim 10, further comprising a rail configured to guide the support arm between the extended position and the retracted position.

12. The lighting system of claim 11, further comprising a gear system configured to control movement of the lighting system, wherein the gear system comprises:
a motor;
a chain;
a motor sprocket configured to drive the chain; and
a sprocket configured to guide the chain around the rail,
wherein, when the gear system is turned on, the chain moves around the rail, moving the support arm between the extended position and the retracted position.

13. The lighting system of claim 1, further comprising:
two support arms configured to position the light source; and
two support beams configured to brace each support arm of the two support arms.

14. A method of preventing accidents comprising:
positioning a light source above a target area by extending the light structure according to claim 1 to an extended position outward from a vehicle;
turning off headlights of the vehicle; and
illuminating the target area from above with the light source.

15. The method of claim 14, further comprising blocking light from the light source with a first flange located on a first side of the light source and a second flange located on a second side of the light source.

16. The method of claim 14, wherein positioning the light source comprises:
actuating an actuator to control the lighting system.

17. The method of claim 14, wherein turning off the headlights of the vehicle comprises:
directing the headlights of the vehicle with a SPDT automotive relay circuit coupled with the headlights and a battery of the vehicle;
interrupting power with a mechanical switch coupled with the headlights and the battery of the vehicle, or
transmitting a sensed signal with a sensor configured to communicate with a computer multiplex-based electrical system of the vehicle.

18. A method of using a lighting system comprising:
stopping a vehicle;
putting the vehicle in neutral;
applying a parking brake of the vehicle;
opening a door of the vehicle to activate a stop arm of the vehicle;
receiving a voltage trigger from the stop arm with a controller;
disengaging a motor brake;
positioning the lighting system coupled to the vehicle to an extended position over a target area, wherein the lighting system is configured to move between a retracted position and the extended position;
engaging the motor brake;
turning on a light source of the lighting system; and
turning off headlights of the vehicle.

19. The method of claim 18, the method comprising
turning off the vehicle;
powering the controller with a battery of the vehicle;
disengaging the motor brake;
returning the lighting system to the retracted position;
engaging the motor brake; and
idling the motor.

20. The method of claim 18, the method further comprising:
closing the door of the vehicle;
deactivating a voltage trigger from the stop arm with the controller;
turning off the light source of the lighting system;
turning on the headlights of the vehicle;
returning the light source to the retracted position;
engaging the motor brake; and
idling the motor.
